(19) United States
(12) Patent Application Publication
(10) Pub. No.: US 2010/0289926 A1
(43) Pub. Date: Nov. 18, 2010

(54) ZOOM LENS AND IMAGING APPARATUS

(76) Inventor: Takashi TANAKA, Saitama-shi (JP)

Correspondence Address: BIRCH STEWART KOLASCH & BIRCH, PO BOX 747, FALLS CHURCH, VA, 22040-0747, US

(21) Appl. No.: 12/777,917

(22) Filed: May 11, 2010

(30) Foreign Application Priority Data
May 12, 2009 (JP) P2009-115272

(51) Int. Cl. H04N 5/262; G02B 15/14; G02B 27/64

(52) U.S. Cl. 348/240.3; 359/687; 396/55; 348/E05.055

(57) ABSTRACT

A zoom lens includes a first lens group having a positive refractive power, a second lens group having a negative refractive power, a third lens group having a positive refractive power, and a fourth lens group having a positive refractive power, which are arranged in this order from an object side. The gap between the lens groups is changed to change power. The third lens group includes at least two partial lens groups. One of the partial lens groups is a camera shake correction group and is moved in a direction vertical to an optical axis to correct a camera shake. The camera shake correction group includes two single lenses, and at least one of the single lenses is a plastic lens.

### CROSS-REFERENCE TO RELATED APPLICATIONS

This application is based upon and claims the benefit of priority from the Japanese Patent Application No. 2009-115272 filed on May 12, 2009; the entire contents of which are incorporated herein by reference.

### BACKGROUND OF THE INVENTION

1. Field of the Invention

The present invention relates to a zoom lens that is appropriately used for a video camera or a digital still camera and an imaging apparatus, and more particularly, to a zoom lens and an imaging apparatus capable of moving some of a plurality of lens groups in a direction vertical to an optical axis to optically correct the blurring of a captured image due to the vibration (tilting) of an optical system, thereby obtaining a high-quality image.

2. Description of the Related Art

When an image is manually captured from a moving object, such as a vehicle, or at a slow shutter speed, vibration is transmitted to an imaging optical system and camera shake occurs, which results in the blurring of a captured image. Therefore, various kinds of vibration-proof optical systems have been proposed which move some lens groups of an imaging optical system in a direction vertical to the optical axis to prevent the blurring of a captured image due to the vibration of the imaging optical system (see Japanese Patent Nos. 3359131 and 4138324 and JP-A-2007-52374).

Japanese Patent No. 3359131 discloses a zoom lens in which four lens groups, that is, a first positive lens group, a second negative lens group, a third positive lens group, and a fourth positive lens group are arranged in this order from an object side, the third lens group is divided into two lens groups, and one of the two lens groups is moved as a camera shake correction (image stabilizer) group. However, in the zoom lens disclosed in Japanese Patent No. 3359131, the camera shake correction group in the third lens group has a relatively large number of lenses, for example, three lenses. Therefore, the size and weight of the camera shake correction group increase, and a large load is applied to a vibration-proof driving system.

Japanese Patent No. 4138324 discloses a zoom lens in which five lens groups, that is, a first positive lens group, a second negative lens group, a third positive lens group, a fourth negative lens group, and a fifth positive lens group are arranged in this order from an object side and the third lens group is moved as a camera shake correction group. In the zoom lens, the camera shake correction group includes two lenses, and the two lenses are made of glass and include a material with a relatively large specific gravity. Therefore, the weight of the camera shake correction group increases, and a large load is applied to the vibration-proof driving system.

JP-A-2007-52374 discloses a zoom lens in which four lens groups, that is, a first positive lens group, a second negative lens group, a third positive lens group, and a fourth positive lens group are arranged in this order from an object side, the third lens group includes a positive single lens element, and the positive single lens element is moved as a camera shake correction group. In the zoom lens, since the camera shake correction group includes a single lens element, the weight of the camera shake correction group is reduced and a small load is applied to the vibration-proof driving system. However, only one single lens element is insufficient to correct chromatic aberration, as compared to the structure in which the camera shake correction group includes two single lenses, and the occurrence of chromatic aberration due to eccentricity during a vibration-proof process is inevitable.

### SUMMARY OF THE INVENTION

The invention has been made in order to solve the above-mentioned problems, and an object of the invention is to provide a zoom lens and an imaging apparatus capable of reducing the weight of a camera shake correction group, a load applied to a vibration-proof driving system, and manufacturing costs and obtaining a good optical performance even when a large camera shake occurs.

According to an aspect of the invention, a zoom lens includes a first lens group having a positive refractive power, a second lens group having a negative refractive power, a third lens group having a positive refractive power, and a fourth lens group having a positive refractive power, which are arranged in this order from an object side. The gap between the lens groups is changed to change power. The third lens group includes at least two partial lens groups. One of the partial lens groups is a camera shake correction group and is moved in a direction vertical to an optical axis to correct a camera shake. The camera shake correction group includes two single lenses, and at least one of the single lenses is a plastic lens.

In the zoom lens according to the above-mentioned aspect, the camera shake correction group includes two single lenses, and at least one of the single lenses is a plastic lens. Therefore, it is possible to reduce the weight of the camera shake correction group, a load applied to the vibration-proof driving system, and manufacturing costs, as compared to the structure in which the camera shake correction group includes three lenses or the structure in which the camera shake correction group includes two or more glass lenses. In addition, it is possible to prevent the occurrence of chromatic aberration due to eccentricity during a vibration-proof process, as compared to the structure in which the camera shake correction group includes only one lens. Therefore, even when a large camera shake occurs, it is possible to obtain a good optical performance.

In the zoom lens according to the above-mentioned aspect, the first lens group and the third lens group may be fixed when power varies and during focusing. The second lens group may be moved along the optical axis when power varies. The fourth lens group may be moved along the optical axis when power varies and during focusing.

The camera shake correction group may have a positive refractive power. The two single lenses may be a positive lens and a negative lens arranged in this order from the object side, and the negative lens may be a plastic lens.

In this case, the positive lens of the camera shake correction group may be a glass lens and satisfy the following Conditional expressions 1 and 2:

νᵢₚ−νᵢₙ>32; and [Conditional expression 1]

ρᵢₚ<3 [Conditional expression 2]

(where νᵢₚ indicates the Abbe number of the positive lens of the camera shake correction group with respect to the d-line, νᵢₙ indicates the Abbe number of the negative lens of the camera shake correction group with respect to the d-line, and ρᵢₚ indicates the specific gravity (g/cm³) of the positive lens of the camera shake correction group).

The negative lens of the camera shake correction group may satisfy the following Conditional expression 3:

0.45<|fᵢₙ|/f_{T}<1.1 [Conditional expression 3]

(where fᵢₙ indicates the focal length of the negative lens of the camera shake correction group and f_{T} indicates the focal length of the entire lens system at a telephoto end).

The third lens group may include three partial lens groups. Among the three partial lens groups, a second partial lens group from the object side may be the camera shake correction group.

In this case, the third lens group may include a plastic lens with, a positive refractive power and satisfy the following Conditional expression 4:

0.5<f₃ₚ/f_{T}<1 [Conditional expression 4]

(where f₃ₚ indicates the focal length of the positive plastic lens of the third lens group and f_{T} indicates the focal length of the entire lens system at the telephoto end).

According to another aspect of the invention, an imaging apparatus includes: the zoom lens according to the above-mentioned aspect; and an imaging device that outputs an image signal corresponding to an optical image formed by the zoom lens.

The imaging apparatus according to the above-mentioned aspect uses as an imaging lens the zoom lens according to the above-Mentioned aspect including the camera shake correction group with a light weight and a good vibration-proof performance. Therefore, it is easy to perform vibration-proof driving and it is possible to effectively correct the blurring of a captured image due to the vibration of the imaging lens.

According to the zoom lens of the above-mentioned aspect, the third lens group includes at least two partial lens groups, one of the partial lens groups is used as the camera shake correction group, the camera shake correction group includes two single lenses, and at least one of the single lenses is a plastic lens. Therefore, it is possible to reduce the weight of the camera shake correction group, a load applied to the vibration-proof driving system, and manufacturing costs. In addition, even when a large camera shake occurs, it is possible to obtain a good optical performance.

The imaging apparatus according to the above-mentioned aspect uses as an imaging lens the zoom lens according to the above-mentioned aspect including the camera shake correction group with a light weight and a good vibration-proof performance. Therefore, it is easy to perform vibration-proof driving, and it is possible to optically correct the blurring of a captured image due to the vibration of the imaging lens and obtain a high-quality image even when vibration occurs.

### BRIEF DESCRIPTION OF THE DRAWINGS

FIG. 1 shows a first structure example of a zoom lens according to an embodiment of the invention and is a cross-sectional view illustrating a lens corresponding to Example 1;

FIG. 2 shows a second structure example of the zoom lens and is a cross-sectional view illustrating a lens corresponding to Example 2;

FIG. 3 shows a third structure example of the zoom lens and is a cross-sectional view illustrating a lens corresponding to Example 3;

FIGS. 4A to 4D are diagrams illustrating all aberrations of the zoom lens according to Example 1 at a wide angle end, in which FIG. 4A shows spherical aberration, FIG. 4B shows astigmatism, FIG. 4C shows distortion, and FIG. 4D shows lateral chromatic aberration;

FIGS. 5A to 5D are diagrams illustrating all aberrations of the zoom lens according to Example 1 in a middle portion, in which FIG. 5A shows spherical aberration, FIG. 5B shows astigmatism, FIG. 5C shows distortion, and FIG. 5D shows lateral chromatic aberration;

FIGS. 6A to 6D are diagrams illustrating all aberrations of the zoom lens according to Example 1 at a telephoto end, in which FIG. 5A shows spherical aberration, FIG. 5B shows astigmatism, FIG. 5C shows distortion, and FIG. 5D shows lateral chromatic aberration;

FIGS. 7A to 7F are aberration diagrams illustrating the lateral aberration of the zoom lens according to Example 1 at the telephoto end;

FIGS. 8A to 8D are diagrams illustrating all aberrations of the zoom lens according to Example 2 at the wide angle end, in which FIG. 8A shows spherical aberration, FIG. 8B shows astigmatism, FIG. 8C shows distortion, and FIG. 8D shows lateral chromatic aberration;

FIGS. 9A to 9D are diagrams illustrating all aberrations of the zoom lens according to Example 2 in the middle portion, in which FIG. 9A shows spherical aberration, FIG. 9B shows astigmatism, FIG. 9C shows distortion, and FIG. 9D shows lateral chromatic aberration;

FIGS. 10A to 10B are diagrams illustrating all aberrations of the zoom lens according to Example 2 at the telephoto end, in which FIG. 10A shows spherical aberration, FIG. 10B shows astigmatism, FIG. 10C shows distortion, and FIG. 10D shows lateral chromatic aberration;

FIGS. 11A to 11F are aberration diagrams illustrating the lateral aberration of the zoom lens according to Example 2 at the telephoto end;

FIGS. 12A to 12D are diagrams illustrating all aberrations of the zoom lens according to Example 3 at the wide angle end, in which FIG. 12A shows spherical aberration, FIG. 12B shows astigmatism, FIG. 12C shows distortion, and FIG. 12D shows lateral chromatic aberration;

FIGS. 13A to 13D are diagrams illustrating all aberrations of the zoom lens according to Example 3 in the middle portion, in which FIG. 13A shows spherical aberration, FIG. 13B shows astigmatism, FIG. 13C shows distortion, and FIG. 13D shows lateral chromatic aberration;

FIGS. 14A to 14D are diagrams illustrating all aberrations of the zoom lens according to Example 3 at the telephoto end, in which FIG. 14A shows spherical aberration, FIG. 14B shows astigmatism, FIG. 14C shows distortion, and FIG. 14D shows lateral chromatic aberration;

FIGS. 15A to 15F are aberration diagrams illustrating the lateral aberration of the zoom lens according to Example 3 at the telephoto end; and

FIG. 16 is an appearance diagram illustrating an example of the structure of a video camera, which is an imaging apparatus according to an embodiment of the invention.

### DESCRIPTION OF THE PREFERRED EMBODIMENTS

Hereinafter, exemplary embodiments of the invention will be described in detail with reference to the accompanying drawings.

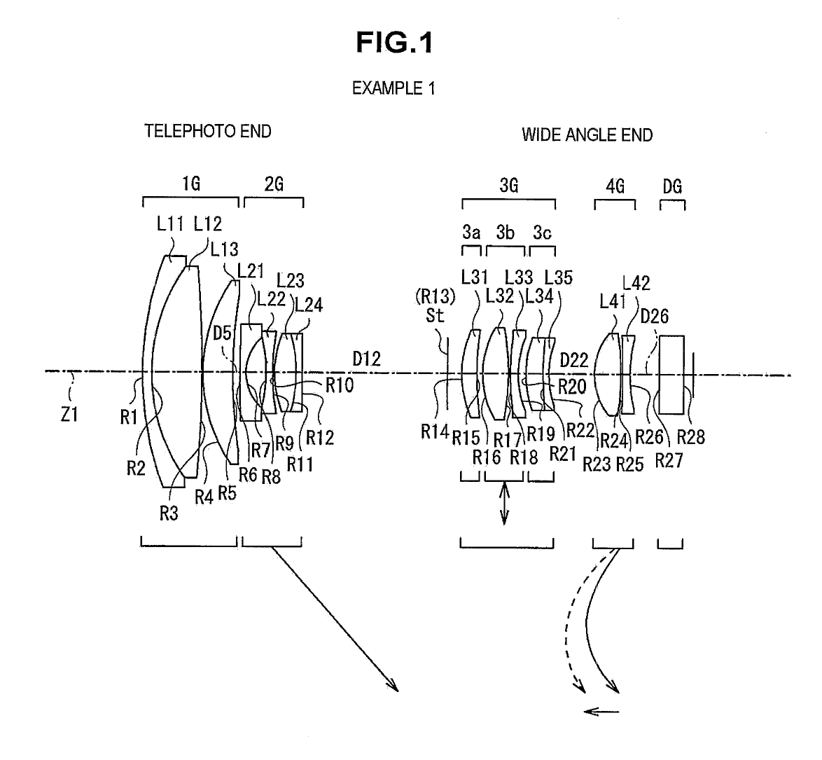

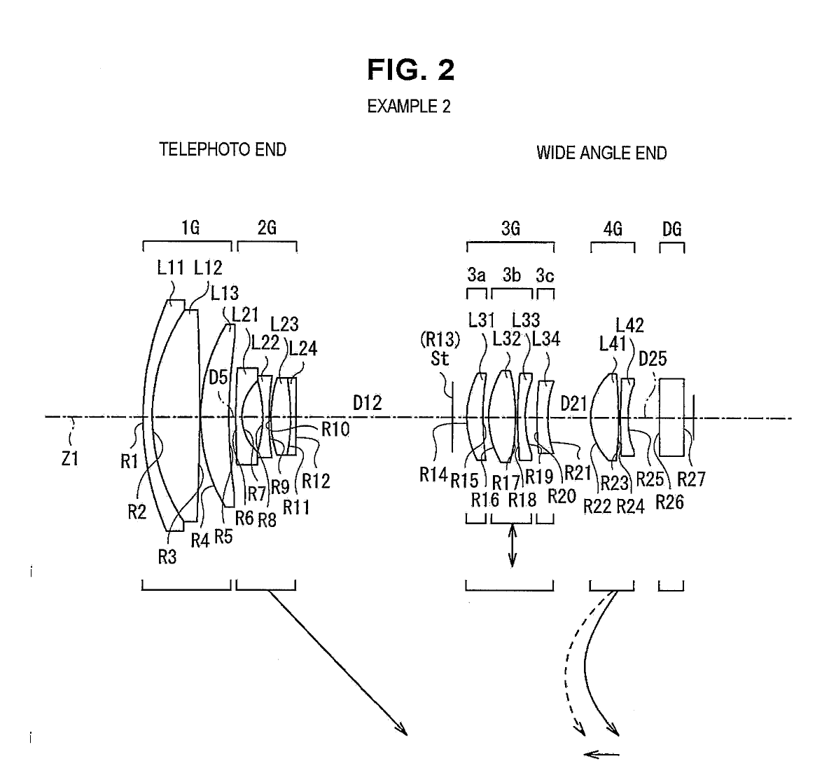

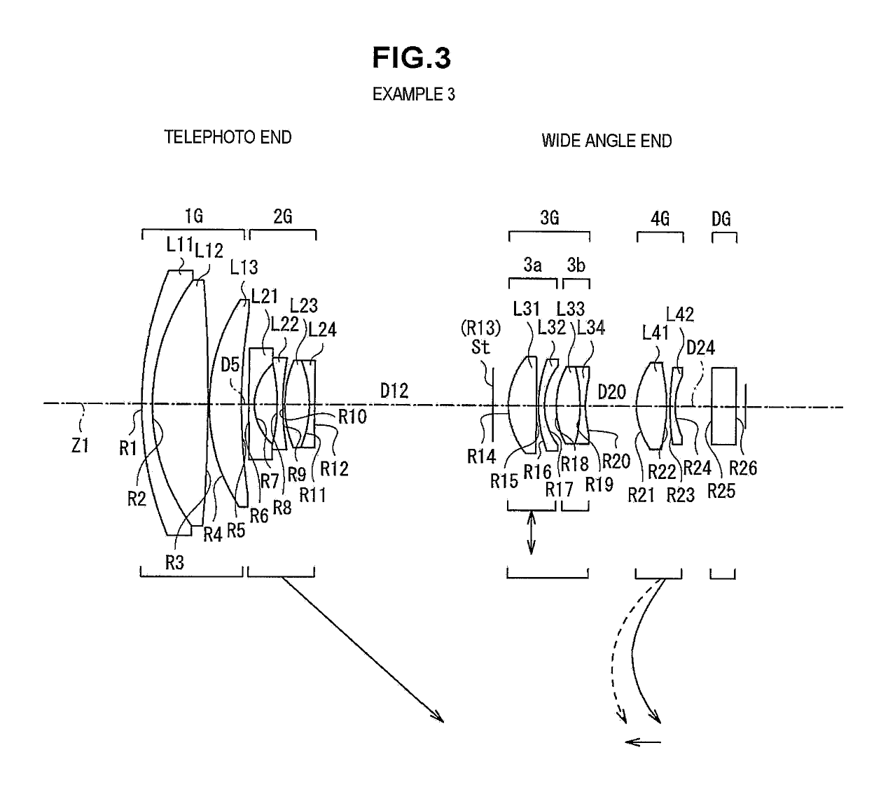

FIG. 1 is a diagram illustrating a first structural example of a zoom lens according to an embodiment of the invention. The structural example corresponds to a lens structure according to a first numerical example, which will be described below. Similarly, FIGS. 2 and 3 are cross-sectional views illustrating second and third structural examples corresponding to lens structures according to second and third numerical examples, which will be described below. In FIGS. 1 to 3, Ri indicates the curvature radius of an i-th surface. In this case, the surface of a lens component closest to an object side is given number 1, and the surface number is sequentially increased toward an image side (image capturing side). In addition, Di indicates the surface spacing between the i-th surface and an (i+1)-th surface on an optical axis Z1. For the symbol Di, a number is given only to the surface spacing between the elements that are moved when power varies.

The zoom lens includes a first lens group 1G, a second lens group 2G, a third lens group 3G, and a fourth lens group 4G from the object side along the optical axis Z1. It is preferable that an optical aperture diaphragm St be arranged in the vicinity of the object side of the third lens group 3G.

The zoom lens may be provided in, for example, a video camera or a digital still camera. A member corresponding to the structure of an imaging unit of a camera provided with the zoom lens is arranged on the image side of the zoom lens. For example, an imaging device, such as a CCD (Charge Coupled Device) or a CMOS (Complementary Metal Oxide Semiconductor), is arranged on the imaging surface (image capturing surface) of the zoom lens. The imaging device outputs an image signal corresponding to an optical image formed by the zoom lens. At least the zoom lens and the imaging device form an imaging apparatus according to this embodiment. Various optical members DG may be arranged between the last lens group (fourth lens group 4G) and the imaging device according to the structure of the camera provided with the lens. For example, plate-shaped optical members, such as a cover glass for protecting the imaging surface, an infrared cut filter, and a low pass filter, may be provided.

FIG. 16 shows an example of the structure of a video camera, which is an example of the imaging apparatus provided with the zoom lens. The video camera includes a camera main body 1 and an imaging lens 2 that is provided at an upper part of the camera main body 1. The camera main body 1 includes, for example, an imaging device, such as a CCD, that outputs an image signal corresponding to an object image formed by the imaging lens 2, a signal processing circuit that processes the image signal output from the imaging device to generate an image, and a storage medium that stores the generated image. A display unit 3 that displays the captured image is attached to the camera main body 1. The zoom lens according to this embodiment may be applied as the imaging lens 2 of the video camera.

The spacing between the lens groups of the zoom lens is changed to change power. Specifically, the first lens group 1G and the third lens group 3G are fixed all the time when power varies and during focusing. The second lens group 2G is moved along the optical axis Z1 when power varies. The fourth lens group 4G is moved along the optical axis Z1 when power varies and during focusing.

Specifically, during infinity focusing, when power varies from the wide angle end to a middle portion and from the middle portion to the telephoto end, each moving group is moved while drawing the trajectories of arrows represented by solid lines in FIGS. 1 to 3. The fourth lens group 4G is moved while drawing the trajectory of an arrow represented by a dashed line during focusing on a short-distance object.

The entire refractive power of the first lens group 1G is positive. The first lens group 1G includes, for example, three lenses L11, L12, and L13. The entire refractive power of the second lens group 2G is negative. The second lens group 2G includes, for example, four lenses L21, L22, L23, and L24. The entire refractive power of the fourth lens group 4G is positive. The fourth lens group 4G includes, for example, two lenses L41 and L42.

The entire refractive power of the third lens group 3G is positive. Third lens group 3G includes at least two partial lens groups. One of the two partial lens groups is a camera shake correction group and is moved in a direction vertical to the optical axis Z1 to correct camera shake. The camera shake correction group includes two single lenses. At least one of the single lenses is a plastic lens.

The camera shake correction group has a positive refractive power. The two single lenses of the camera shake correction group are a positive lens and a negative lens arranged in this order from the object side. It is preferable that the negative lens be a plastic lens. In this case, the positive lens of the camera shake correction group is a glass lens and it is preferable that the positive lens satisfy the following Conditional expressions 1 and 2:

νᵢₚ−νᵢₙ<32; and [Conditional expression 1]

ρᵢₚ<3 [Conditional expression 2]

(where νᵢₚ indicates the Abbe number of the positive lens of the camera shake correction group with respect to the d-line, νᵢₙ indicates the Abbe number of the negative lens of the camera shake correction group with respect to the d-line, and ρᵢₚ indicates the specific gravity (g/cm³) of the positive lens of the camera shake correction group).

It is preferable that the negative lens of the camera shake correction group satisfy the following Conditional expression 3:

0.45<|fᵢₙ|/f_{T}<1.1 [Conditional expression 3]

(where fᵢₙ indicates the focal length of the negative lens of the camera shake correction group, and f_{T} indicates the focal length of the entire lens system at the telephoto end).

In the structural examples shown in FIGS. 1 and 2, the third lens group 3G includes a first partial lens group 3a, a second partial lens group 3b, and a third partial lens group 3c arranged in this order from the object side. The second partial lens group 3b is the camera shake correction group. In structural examples shown in FIGS. 1 and 2, the first partial lens group 3a includes one lens L31, and the second partial lens group 3b includes two lenses L32 and L33. The third partial lens group 3c includes two lenses L34 and L35 in structural example shown in FIG. 1, and includes one lens L34 in the structural example shown in FIG. 2. In the structural examples shown in FIGS. 1 and 2, of the two lenses L32 and L33 of the second partial lens group 3b, the object-side lens L32 is a positive lens made of glass, and the image-side lens L33 is a negative lens made of plastic.

As in the structural examples shown in FIGS. 1 and 2, when the third lens group 3G includes three partial lens groups and the second partial lens group 3b of the three partial lens groups is the camera shake correction group, it is preferable that the third lens group 3G include a plastic lens with a positive refractive power and satisfy the following Conditional expression 4:

0.5<f₃ₚ/f_{T}<1 [Conditional expression 4]

(where f₃ₚ indicates the focal length of the positive plastic lens of the third lens group 3G, and f_{T} indicates the focal length of the entire lens system at the telephoto end).

For example, it is preferable that the lens L31 of the first partial lens group 3a be a plastic lens with a positive refractive power.

In the structural example shown in FIG. 3, the third lens group 3G includes a first partial lens group 3a and a second partial lens group 3b arranged in this order from the object side. The first partial lens group 3a is the camera shake correction group. In the structural example shown in FIG. 3, the first partial lens group 3a includes two lenses L31 and L32, and the second partial lens group 3b includes two lenses L33 and L34. In the structural example shown in FIG. 3, of the two lenses L31 and L32 of the first partial lens group 3a, the object-side lens L31 is a positive lens made of glass, and the image-side lens L32 is a negative lens made of plastic.

Next, the operation and effects of the zoom lens having the above-mentioned structure will be described.

In the zoom lens, the third lens group 3G includes at least two partial lens groups, and one partial lens group is a camera shake correction group. The camera shake correction group includes two single lenses, and at least one single lens is a plastic lens. Therefore, it is possible to reduce the weight of the camera shake correction group as compared to the structure in which the camera shake correction group includes three lenses or the structure in which the camera shake correction group includes two or more glass lenses. In this way, it is possible to reduce manufacturing costs while reducing a load applied to a vibration-proof driving system. The plastic lens is formed by injection molding. Therefore, it is easy to form an aspheric lens and it is possible to reduce manufacturing costs during mass production. In general, the specific gravity of the plastic lens is in the range of 0.9 to 1.3 G/cm³, which is significantly less than a specific gravity of 2.3 to 5.6 g/cm³ of the optical glass.

Since the camera shake correction group includes two single lenses, it is possible to prevent the generation of chromatic aberration due to eccentricity during a vibration-proof process, as compared to the structure in which the camera shake correction group includes only one lens. Therefore, even when a large camera shake occurs, it is possible to obtain a good optical performance.

In the zoom lens, the first lens group 1G and the third lens group 3G are fixed when power varies and during focusing, the second lens group 2G is moved when power varies, and the fourth lens group 4G is moved when power varies and during focusing. In this way, since only two moving groups are provided for power variation or focusing, the structure of the zoom lens is simplified. In particular, when a moving picture is captured, image blur is less likely to occur when power varies or focusing is performed.

The zoom lens is a so-called telephoto type in which the camera shake correction group has a positive refractive power, two single lenses of the camera shake correction group are a positive lens and a negative lens arranged in this order from the object side, and the negative lens is a plastic lens. Therefore, it is possible to reduce the size of the zoom lens and correct chromatic aberration due to eccentricity during a vibration-proof process. In addition, it is possible to reduce manufacturing costs. In the camera shake correction group, the absolute value of the refractive power of the negative lens is less than that of the positive lens. Therefore, it is possible to reduce a variation in the refractive power of the plastic lens due to temperature variation and the focus is less likely to be moved when the temperature is changed. Since the positive lens of the camera shake correction group is a glass lens, it is possible to obtain a sufficient positive refractive power to correct camera shake, without considering a variation in refractive power due to temperature variation.

In the zoom lens, the third lens group 3G includes three partial lens groups, and the second partial lens group from the object side among the three partial lens groups is the camera shake correction group. Therefore, the distribution of the refractive power of each partial lens group in the third lens group 3G is adjusted such that the camera shake correction group has an optimum refractive power and the amount of movement of the camera shake correction group during a vibration-proof process becomes appropriate. In addition, since the third lens group 3G includes one plastic lens with a positive refractive power, the third lens group 3G has an aspheric surface. Therefore, it is possible to obtain a good optical performance and reduce manufacturing costs. Since the third lens group 3G includes two positive and negative plastic lenses in addition to the negative plastic lens of the camera shake correction group, a variation in refractive power due to temperature variation is cancelled by the positive and negative refractive powers of the plastic lenses. Therefore, the focus is less likely to be moved when the temperature is changed.

Conditional expression 1 defines the Abbe numbers of the positive lens and the negative lens of the camera shake correction group with respect to the d-line. If the difference between the Abbe numbers of the positive and negative lenses is more than the lower limit of Conditional expression 1, the chromatic aberration of the camera shake correction group is not sufficiently corrected. When the zoom lens is moved in a direction that is substantially vertical to the optical axis, chromatic aberration is generated due to eccentricity. As a result, the performance deteriorates greatly.

Conditional expression 2 defines the specific gravity of the positive, lens in the camera shake correction group, and is for reducing the weight of the camera shake correction group. If the specific gravity of the positive lens is more than the upper limit of Conditional expression 2, the overall weight of the camera shake correction group increases, and a large load is applied to a vibration-proof driving system. In order to further improve the effects, it is preferable that the numerical range of Conditional expression 2 satisfy the following Conditional expression 2′:

ρᵢₚ<2.8. [Conditional expression 2′]

Conditional expression 3 defines the refractive power of the negative lens in the camera shake correction group. If the ratio is less than the lower limit of Conditional expression 3, the refractive power of the negative lens in the camera shake correction group is excessively high. In this case, it is difficult to prevent a variation in refractive power due to temperature variation, and the focus is moved greatly when the temperature is changed. On the other hand, if the ratio is more than the upper limit of Conditional expression 3, the refractive power of the negative lens in the camera shake correction group is excessively low. In this case, the chromatic aberration of the camera shake correction group is not sufficiently corrected. When the zoom lens is moved in a direction that is substantially vertical to the optical axis, chromatic aberration is generated due to eccentricity. As a result, the performance deteriorates greatly. In order to further improve the effects, it is preferable that the numerical range of Conditional expression 3 satisfy the following Conditional expression 3′:

0.5<|fᵢₙ|/f_{T}<0.95. [Conditional expression 3′]

Conditional expression 4 defines the refractive power of the positive plastic lens in the third lens group 3G. If the ratio is less than the lower limit of Conditional expression 4, the refractive power of the positive plastic lens in the third lens group 3G is excessively high. In this case, it is difficult to prevent a variation in refractive power due to temperature variation, and the focus is moved greatly when the temperature is changed. On the other hand, if the ratio is more than the upper limit of Conditional expression 4, the refractive power of the positive plastic lens in the third lens group 3G is excessively low. In this case, it is difficult to reduce the overall length of the optical system. In order to further improve the effects, it is preferable that the numerical range of Conditional expression 4 satisfy the following Conditional expression 4′:

0.55<f₃ₚ/f_{T}<0.85. [Conditional expression 4′]

As described above, according to the zoom lens of this embodiment, the third lens group 3G includes at least two partial lens groups, one of the two partial lens groups is the camera shake correction group including two single lenses, and at least one of the two single lenses is a plastic lens. Therefore, it is possible to reduce, the weight of the camera shake correction group and reduce manufacturing costs while reducing a load applied to the vibration-proof driving system. In addition, even when a large camera shake occurs, it is possible to obtain a good optical performance. According to the imaging apparatus provided with the zoom lens according to this embodiment, it is easy to perform vibration-proof driving and it is possible to optically correct the blurring of a captured image due to the vibration of the imaging lens. Therefore, even when vibration occurs, it is possible to obtain a high-quality image.

### EXAMPLES

Next, detailed numerical examples of the zoom lens according to this embodiment will be described. A plurality of numerical examples will be partially described.

### Example 1

Tables 1 to 3 show detailed lens data corresponding to the structure of the zoom lens shown in FIG. 1. In particular, the basic lens data of the zoom lens is shown in Table 1, and other data is shown in Tables 2 and 3. In the lens data shown in Table 1, an i-th surface number is written in the field of a surface number Si. In this case, the surface of a component closest to the object side in the zoom lens according to Example 1 is given number 1, and the surface number is sequentially increased toward the image side. The curvature radius (mm) of the i-th surface from the object side is written in the field of a curvature radius Ri so as to correspond to Ri shown in FIG. 1. The spacing (mm) between the i-th surface Si and an (i+1)-th surface Si+1 on the optical axis is written in the field of a surface spacing Di. The refractive index of a j-th optical component from the object side with respect to the d-line (wavelength: 587.6 nm) is written in the field of Ndj. The Abbe number of the j-th optical component from the object side with respect to the d-line is written in the field of νdj. In addition, Table 1 also shows the paraxial focal length f (mm), the angle of view (2Ω), and the F number (FNO.) of the entire lens system at the wide angle end, the middle portion, and the telephoto end as the other data.

In the zoom lens according to Example 1, the second lens group 2G and the fourth lens group 4G are moved along the optical axis when power varies. Therefore, the surface spacing D5 between the first lens group and the second lens group, the surface spacing D12 between the second lens group and the third lens group, the surface spacing D22 between the third lens group and the fourth lens group, and the surface spacing D26 between the fourth lens group and the optical member vary. Table 2 shows the values of the surface spacings D5, D12, D22, and D26 at the wide angle end, the middle portion, and the telephoto end as data when power varies.

In the lens data shown in Table 1, the symbol ‘*’ added to the left side of the surface number indicates an aspheric lens surface. In the zoom lens according to Example 1, an object-side surface S14 of the lens L31 and an object-side surface S18 of the lens L33 in the third lens group 3G, and both surfaces S25 and S26 of the lens L42 in the fourth lens group 4G are all aspheric surfaces. The basic lens data shown in Table 1 includes the curvature radii of the aspheric surfaces near the optical axis.

Table 3 shows aspheric data of the zoom lens according to Example 1. In the numerical values represented as the aspheric data in Table 3, ‘E’ indicates the exponent of 10, and the number represented by an exponential function having 10 as a base is multiplied by a number before ‘E’. For example, ‘1.0E-02 ’ indicates ‘1.0×10^{-2’.}

The aspheric data of the zoom lens according to Example 1 includes coefficients Aₙ and K of Aspheric expression A given below:

Z=C·h²/{1+(1−K·C²·h²)^{1/2}}+ΣAₙ·hⁿ

(where n is an integer equal to or greater than 3, Z indicates the depth (mm) of an aspheric surface in the optical axis direction, h indicates the distance (height) (mm) from the optical axis to a lens surface (h≧0), K indicates eccentricity, C indicates a paraxial curvature=1/R (R is a paraxial curvature radius), and Aₙ indicates an n-order aspheric coefficient).

Specifically, Z indicates the length (mm) of a perpendicular line that drops from a point on an aspheric surface at a height h from the optical axis to a tangent plane to the top of the aspheric surface (a plane vertical to the optical axis).

In the zoom lens according to Example 1, each of the aspheric surfaces is represented by effectively using coefficients A₃ to A₁₂ as the aspheric coefficient Aₙ.

TABLE 1
EXAMPLE 1, BASIC LENS DATA

| | | | | Si | Ri | Di | Ndj | νdj |
|---|---|---|---|---|---|---|---|---|
| | | | | (SURFACE | (CURVATURE | (SURFACE | (REFRACTIVE | (ABBE |
| | | | | NUMBER) | RADIUS) | SPACING) | INDEX) | NUMBER) |
| | | | | 1 | 33.7850 | 0.950 | 1.84661 | 23.9 |
| | | | | 2 | 19.395 | 5.210 | 1.49700 | 81.5 |
| | | 1G | {open oversize brace} | 3 | −124.8851 | 0.100 | | |
| | | | | 4 | 16.9595 | 3.110 | 1.75500 | 52.3 |
| | | | | 5 | 53.8243 | D5(VARIABLE) | | |
| | | | | 6 | 127.4734 | 0.650 | 1.88300 | 40.8 |
| | | | | 7 | 4.8502 | 2.080 | | |
| | | | | 8 | −14.7263 | 0.630 | 1.88300 | 40.8 |
| | | 2G | {open oversize brace} | 9 | 24.3501 | 0.200 | | |
| | | | | 10 | 10.7827 | 2.280 | 1.80809 | 22.8 |
| | | | | 11 | −12.8871 | 0.580 | 1.83481 | 42.7 |
| | | | | 12 | 160.1497 | D12(VARIABLE) | | |
| | | | | 13(APERTURE | — | 1.500 | | |
| | | | | DIAPHRAGM) | | | | |
| | | | | *14 | 10.5089 | 1.560 | 1.51007 | 56.2 |
| | | 3a | {open oversize brace} | | | | | |
| | | | | 15 | 32.9998 | 0.600 | | |
| | | | | 16 | 9.4628 | 2.670 | 1.51680 | 64.2 |
| | | | | 17 | −24.8730 | 0.200 | | |
| 3G | {open oversize brace} | 3b | {open oversize brace} | *18 | 24.1534 | 0.800 | 1.60595 | 27.0 |
| | | | | 19 | 10.0506 | 0.800 | | |
| | | | | 20 | 10.8141 | 1.750 | 1.48749 | 70.2 |
| | | 3c | {open oversize brace} | 21 | 34.2968 | 0.600 | 1.80518 | 25.4 |
| | | | | 22 | 9.1725 | D22(VARIABLE) | | |
| | | | | 23 | 6.7022 | 2.750 | 1.58913 | 61.1 |
| | | | | 24 | −25.6930 | 0.200 | | |
| | | 4G | {open oversize brace} | *25 | −3130.5075 | 0.800 | 1.60595 | 27.0 |
| | | | | *26 | 17.1562 | D26(VARIABLE) | | |
| | | | | 27 | ∞ | 2.500 | 1.51680 | 64.2 |
| | | DG | {open oversize brace} | | | | | |
| | | | | 28 | ∞ | | | |

(*ASPHERIC SURFACE)

TABLE 2
EXAMPLE 1, VARIABLE SURFACE SPACING DATA

| SURFACE | WIDE | MIDDLE | TELEPHOTO |
|---|---|---|---|
| SPACING | ANGLE END | PORTION | END |
| D5 | 0.700 | 9.017 | 13.983 |
| D12 | 15.080 | 6.763 | 1.797 |
| D22 | 4.700 | 2.196 | 4.714 |
| D26 | 2.999 | 5.503 | 2.985 |

TABLE 3
EXAMPLE 2, ASPHERIC DATA

| | SURFACE NUMBER | | | |
|---|---|---|---|---|
| COEFFICIENT | 14 | 18 | 25 | 26 |
| K | 0.13945 | −1.08225 | 1.00017 | 1.05145 |
| A3 | −1.12504E−05 | −8.97159E−06 | −5.21830E−04 | −3.96869E−04 |
| A4 | −4.25426E−05 | −2.34502E−04 | −3.57355E−04 | 3.04135E−04 |
| A5 | −1.16547E−06 | −2.22374E−05 | −1.98091E−05 | 3.83970E−05 |
| A6 | 3.88410E−06 | −6.91248E−07 | −5.40994E−07 | 4.25126E−06 |
| A7 | 1.82213E−07 | 3.10583E−07 | 9.83488E−08 | 4.62326E−07 |
| A8 | −3.32404E−07 | 6.05797E−08 | 2.64768E−08 | 3.04850E−08 |
| A9 | −4.91826E−09 | −1.46472E−09 | 4.55348E−09 | 2.84798E−09 |
| A10 | 8.41754E−09 | −3.76680E−09 | 6.43405E−10 | 3.31745E−10 |
| A11 | 0.00000E+00 | 0.00000E+00 | 1.34242E−11 | 2.19281E−12 |
| A12 | 0.00000E+00 | 0.00000E+00 | 1.56323E−12 | 3.04032E−13 |

### Numerical Examples 2 and 3

Similar to the zoom lens according to Example 1, Tables 4 to 6 show detailed lens data corresponding to the structure of a zoom lens according to Example 2 shown in FIG. 2. Similarly, Tables 7 to 9 show detailed lens data corresponding to the structures of a zoom lens according to Example 3 shown in FIG. 3.

In the zoom lens according to Example 2, the object-side surface S14 of the lens L31 and the object-side surface S18 of the lens L33 in the third lens group 3G, and both surfaces S24 and S25 of the lens L42 in the fourth lens group 4G are aspheric surfaces. In the zoom lens according to Example 3, the object-side surface S14 of the lens L31 and the image-side surface S17 of the lens L32 in the third lens group 3G, and both surfaces S21 and S22 of the lens L41 in the fourth lens group 4G are aspheric surfaces.

TABLE 4
EXAMPLE 2, BASIC LENS DATA

| | | | | Si | Ri | Di | Ndj | νdj |
|---|---|---|---|---|---|---|---|---|
| | | | | (SURFACE | (CURVATURE | (SURFACE | (REFRACTIVE | (ABBE |
| | | | | NUMBER) | RADIUS) | SPACING) | INDEX) | NUMBER) |
| | | | | 1 | 30.3160 | 0.950 | 1.92286 | 20.9 |
| | | | | 2 | 19.9968 | 4.910 | 1.49700 | 81.5 |
| | | 1G | {open oversize brace} | 3 | −253.0345 | 0.100 | | |
| | | | | 4 | 18.6903 | 2.920 | 1.77250 | 49.6 |
| | | | | 5 | 56.1780 | D5(VARIABLE) | | |
| | | | | 6 | 88.1330 | 0.650 | 1.88300 | 40.8 |
| | | | | 7 | 5.0164 | 2.150 | | |
| | | | | 8 | −12.9006 | 0.630 | 1.88300 | 40.8 |
| | | 2G | {open oversize brace} | 9 | 27.8370 | 0.200 | | |
| | | | | 10 | 12.6477 | 2.050 | 1.92286 | 20.9 |
| | | | | 11 | −23.8130 | 0.580 | 1.88300 | 40.8 |
| | | | | 12 | 87352.3540 | D12(VARIABLE) | | |
| | | | | 13(APERTURE | — | 1.500 | | |
| | | | | DIAPHRAGM) | | | | |
| | | | | *14 | 9.3834 | 1.670 | 1.51007 | 56.2 |
| | | 3a | {open oversize brace} | | | | | |
| | | | | 15 | 32.9998 | 0.600 | | |
| | | | | 16 | 9.4584 | 2.770 | 1.48749 | 70.2 |
| | | | | 17 | −19.7505 | 0.200 | | |
| 3G | {open oversize brace} | 3b | {open oversize brace} | *18 | 26.4817 | 0.800 | 1.60595 | 27.0 |
| | | | | 19 | 11.5157 | 1.200 | | |
| | | | | 20 | 32.6611 | 1.130 | 1.92286 | 20.9 |
| | | 3c | {open oversize brace} | | | | | |
| | | | | 21 | 11.5722 | D21(VARIABLE) | | |
| | | | | 22 | 6.3340 | 2.890 | 1.58913 | 61.1 |
| | | | | 23 | −40.0456 | 0.200 | | |
| | | 4G | {open oversize brace} | *24 | 32.8504 | 0.800 | 1.60595 | 27.0 |
| | | | | *25 | 12.5759 | D25(VARIABLE) | | |
| | | | | 26 | ∞ | 2.500 | 1.51680 | 64.2 |
| | | DG | {open oversize brace} | | | | | |
| | | | | 27 | ∞ | | | |

(*ASPHERIC SURFACE)

TABLE 5
EXAMPLE 2, VARIABLE SURFACE SPACING DATA

| SURFACE | WIDE | MIDDLE | TELEPHOTO |
|---|---|---|---|
| SPACING | ANGLE END | PORTION | END |
| D5 | 0.700 | 9.611 | 15.101 |
| D12 | 16.190 | 7.279 | 1.789 |
| D21 | 4.450 | 2.184 | 4.600 |
| D25 | 3.260 | 5.526 | 3.109 |

TABLE 6
EXAMPLE 2, ASPHERIC DATA

| | SURFACE NUMBER | | | |
|---|---|---|---|---|
| COEFFICIENT | 14 | 18 | 24 | 25 |
| K | 0.00784 | −0.66086 | 1.00234 | 1.22059 |
| A3 | 4.65030E−05 | −1.07870E−05 | −8.49995E−04 | −7.18500E−04 |
| A4 | −4.53879E−05 | −2.88968E−04 | −3.68411E−04 | 4.21548E−04 |
| A5 | −1.21457E−06 | −2.22732E−05 | −4.92163E−06 | 7.70103E−05 |
| A6 | 4.30859E−06 | −9.51477E−07 | 2.17238E−06 | 1.39280E−05 |
| A7 | 2.62489E−07 | 2.73745E−07 | 3.57961E−07 | 2.42539E−06 |
| A8 | −3.32406E−07 | 6.64889E−08 | 1.97698E−08 | 2.51505E−07 |
| A9 | −6.94753E−09 | −7.79252E−10 | −6.55393E−09 | 3.89804E−08 |
| A10 | 7.94214E−09 | −4.50658E−09 | −2.93829E−09 | 8.46437E−09 |
| A11 | 0.00000E+00 | 0.00000E+00 | −1.22882E−10 | 1.41116E−10 |
| A12 | 0.00000E+00 | 0.00000E+00 | −2.76584E−11 | 3.15212E−11 |

TABLE 7
EXAMPLE 3, BASIC LENS DATA

| | | | | Si | Ri | Di | Ndj | νdj |
|---|---|---|---|---|---|---|---|---|
| | | | | (SURFACE | (CURVATURE | (SURFACE | (REFRACTIVE | (ABBE |
| | | | | NUMBER) | RADIUS) | SPACING) | INDEX) | NUMBER) |
| | | | | 1 | 36.3180 | 1.100 | 1.84661 | 23.9 |
| | | | | 2 | 21.8599 | 5.760 | 1.49700 | 81.5 |
| | | 1G | {open oversize brace} | 3 | −161.9040 | 0.100 | | |
| | | | | 4 | 19.8664 | 3.350 | 1.69680 | 55.5 |
| | | | | 5 | 63.5181 | D5(VARIABLE) | | |
| | | | | 6 | 207.7793 | 0.620 | 1.88300 | 40.8 |
| | | | | 7 | 5.5663 | 2.360 | | |
| | | | | 8 | −18.1489 | 0.560 | 1.88300 | 40.8 |
| | | 2G | {open oversize brace} | 9 | 25.5394 | 0.200 | | |
| | | | | 10 | 11.5877 | 2.550 | 1.80809 | 22.8 |
| | | | | 11 | −12.4087 | 0.550 | 1.88300 | 40.8 |
| | | | | 12 | 142.4457 | D12(VARIABLE) | | |
| | | | | 13 (APERTURE | — | 1.600 | | |
| | | | | DIAPHRAGM) | | | | |
| | | | | *14 | 7.5188 | 2.920 | 1.52500 | 70.4 |
| | | | | 15 | −357.390 | 0.200 | | |
| | | 3a | {open oversize brace} | 16 | 13.4514 | 0.640 | 1.60595 | 27.0 |
| 3G | {open oversize brace} | | | *17 | 7.1886 | 1.200 | | |
| | | | | 18 | 8.4479 | 2.470 | 1.67003 | 47.2 |
| | | 3b | {open oversize brace} | 19 | −17.0672 | 0.560 | 1.83481 | 42.7 |
| | | | | 20 | 12.1697 | D20(VARIABLE) | | |
| | | | | *21 | 7.1223 | 3.110 | 1.69350 | 53.2 |
| | | | | *22 | −14.2210 | 0.340 | | |
| | | 4G | {open oversize brace} | 23 | 25.6596 | 0.550 | 1.92286 | 20.9 |
| | | | | 24 | 7.4907 | D24(VARIABLE) | | |
| | | | | 25 | ∞ | 2.500 | 1.51680 | 64.2 |
| | | DG | {open oversize brace} | | | | | |
| | | | | 26 | ∞ | | | |

(*ASPHERIC SURFACE)

TABLE 8
EXAMPLE 3, VARIABLE SURFACE SPACING DATA

| SURFACE | WIDE | MIDDLE | TELEPHOTO |
|---|---|---|---|
| SPACING | ANGLE END | PORTION | END |
| D5 | 0.720 | 11.098 | 17.507 |
| D12 | 18.480 | 8.102 | 1.693 |
| D20 | 5.300 | 2.522 | 4.820 |
| D24 | 3.764 | 6.542 | 4.244 |

TABLE 9
EXAMPLE 3, ASPHERIC DATA

| | SURFACE NUMBER | | | |
|---|---|---|---|---|
| COEFFICIENT | 14 | 17 | 21 | 22 |
| K | 1.00000 | 1.00000 | 1.00000 | 1.00000 |
| A3 | 5.45416E−05 | −3.58495E−05 | −2.17604E−04 | −2.57442E−04 |
| A4 | −1.46696E−04 | 2.48285E−04 | −2.16487E−04 | 8.36273E−04 |
| A5 | 3.03756E−05 | 3.02284E−06 | −4.23736E−05 | −4.61672E−05 |
| A6 | −5.07964E−06 | 9.88746E−07 | −5.02586E−08 | −8.67198E−06 |
| A7 | −5.48939E−07 | 2.42263E−07 | 1.77396E−07 | −2.76696E−08 |
| A8 | 1.02427E−08 | 4.70696E−08 | 1.32819E−08 | 1.33645E−07 |
| A9 | 7.20645E−09 | 8.30113E−09 | 1.02965E−09 | 2.34096E−08 |
| A10 | 9.05205E−10 | 1.74697E−09 | 2.24761E−10 | 3.44550E−09 |
| A11 | 2.34982E−11 | 2.59253E−10 | 2.98314E−11 | 3.48835E−10 |
| A12 | −8.78885E−12 | 4.18957E−11 | 2.47413E−12 | 3.99913E−11 |
| A13 | −1.95322E−12 | 4.99312E−12 | −1.88932E−13 | 3.58951E−12 |
| A14 | −3.22022E−13 | 6.80606E−13 | −1.13710E−13 | 3.95701E−13 |
| A15 | −3.35235E−14 | 7.08846E−14 | −2.32414E−14 | 3.56606E−14 |
| A16 | −3.44690E−15 | 8.68792E−15 | −4.37796E−15 | 4.07832E−15 |

Table 10 shows the amount of movement of the correction lens group (the amount of eccentricity shifted in the horizontal direction) when a camera shake of 0.3° occurs at the telephoto end in Examples 1 to 3. Table 11 shows values related to Conditional expressions according to Examples 1 to 3. For Conditional expression 2, the positive lens of the camera shake correction group is made of a glass material BSC7 manufactured by HOYA CORPORATION in Example 1, a glass material S-FSL5 manufactured by OHARA INC. in Example 2, and a glass material K-PMK30 manufactured by SUMITA OPTICAL GLASS INC. in Example 3.

TABLE 10
AMOUNT OF ECCENTRICITY OF CORRECTION LENS GROUP
SHIFTED IN HORIZONTAL DIRECTION WHEN CAMERA SHAKE
OF 0.3° OCCURS AT TELEPHOTO END (mm)

| | |
|---|---|
| EXAMPLE 1 | 0.33 |
| EXAMPLE 2 | 0.30 |
| EXAMPLE 3 | 0.43 |

TABLE 11
VALUES RELATED TO CONDITIONAL EXPRESSION

| EXPRESSION | EXAMPLE 1 | EXAMPLE 2 | EXAMPLE 3 |
|---|---|---|---|
| CONDITIONAL | 37.2 | 43.2 | 43.4 |
| EXPRESSION 1 | | | |
| νᵢₚ − νᵢₙ | | | |
| CONDITIONAL | 2.52 | 2.46 | 2.60 |
| EXPRESSION 2 | | | |
| ρᵢₚ | | | |
| CONDITIONAL | 0.736 | 0.870 | 0.590 |
| EXPRESSION 3 | | | |
| \|fᵢₙ\|/f_{T} | | | |
| CONDITIONAL | 0.749 | 0.637 | — |
| EXPRESSION 4 | | | |
| f₃ₚ/f_{T} | | | |

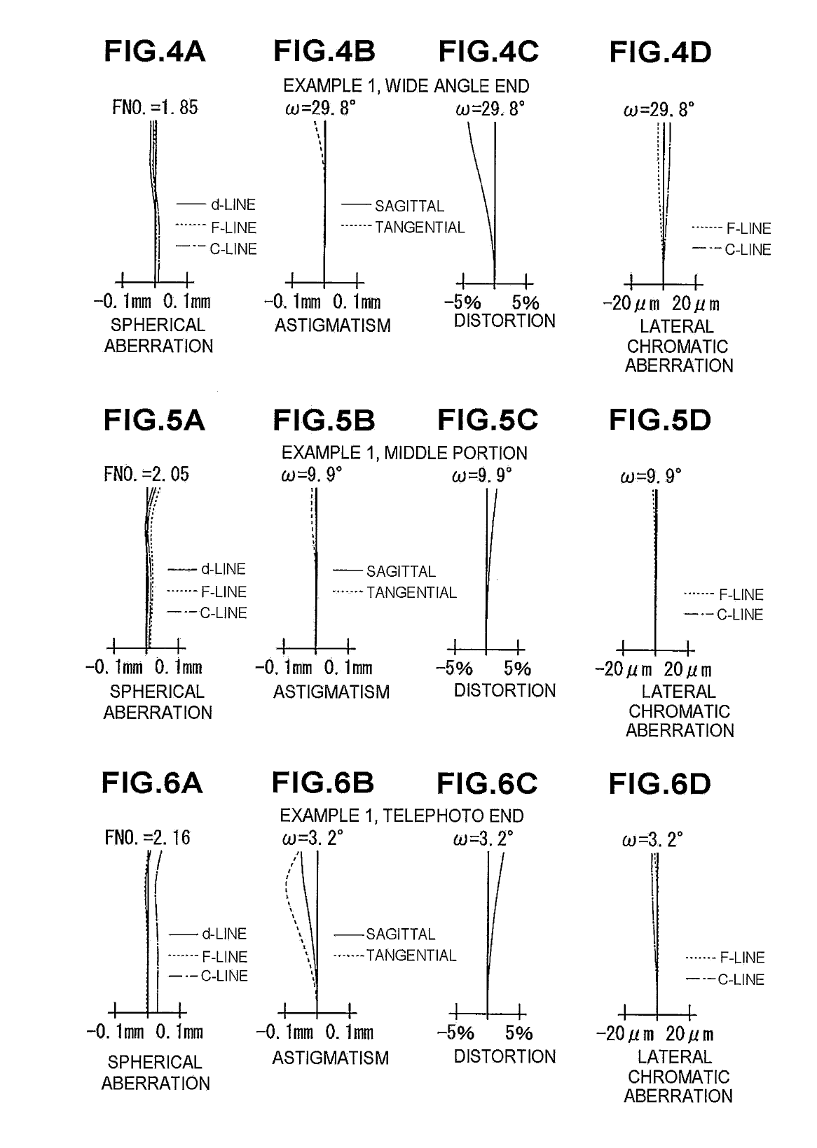

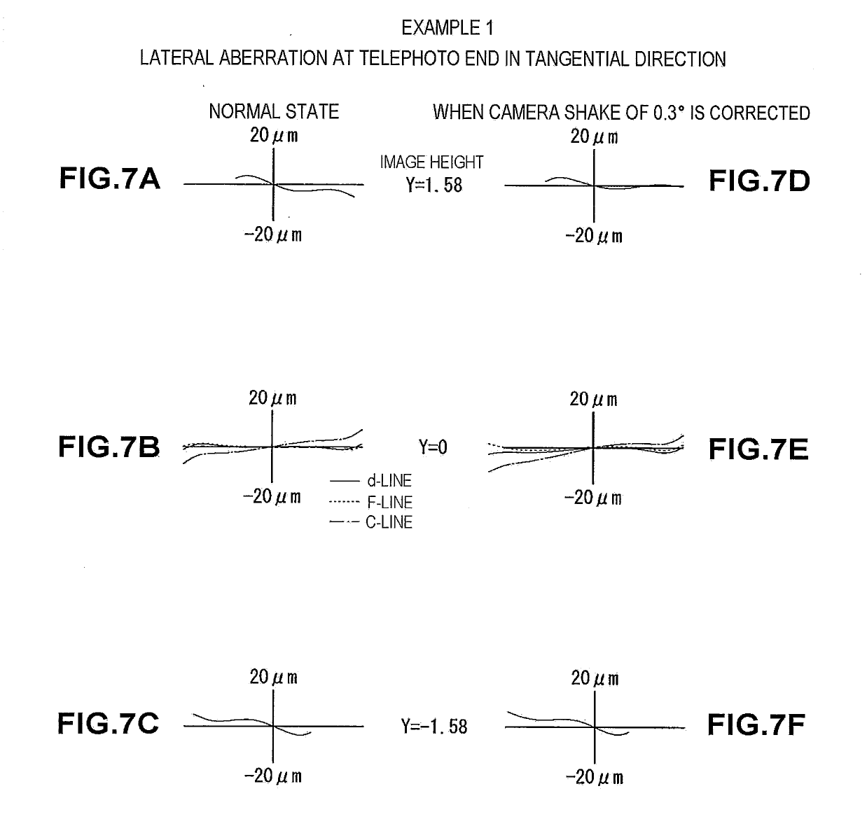

FIGS. 4A to 4D show the spherical aberration, astigmatism, distortion, and lateral chromatic aberration of the zoom lens according to Example 1 at the wide angle end (during infinity focusing), respectively. FIGS. 5A to 5D show the spherical aberration, astigmatism, distortion, and lateral chromatic aberration of the zoom lens according to Example 1 at the middle portion (during infinity focusing), respectively. FIGS. 6A to 6D show the spherical aberration, astigmatism, distortion, and lateral chromatic aberration of the zoom lens according to Example 1 at the telephoto end (during infinity focusing), respectively. Each of the aberration diagrams shows aberration when the d-line (wavelength: 587.6 nm) is used as a reference wavelength. The spherical aberration diagram and the lateral chromatic aberration diagram show aberration with respect to the C-line (wavelength: 656.27 nm) and the F-line (wavelength: 486.13 nm). In the astigmatism diagrams, a solid line indicates aberration in a sagittal direction, and a dotted line indicates aberration in a tangential direction. In addition, FNO. indicates an F number, and w indicates a half angle of view. FIGS. 7A to 7F show the lateral aberration of the zoom lens according to Example 1 at the telephoto end. In particular, FIGS. 7A to 7C show the lateral aberration in a normal state, and FIGS. 7D to 7F show the lateral aberration when a camera shake of 0.3° is corrected.

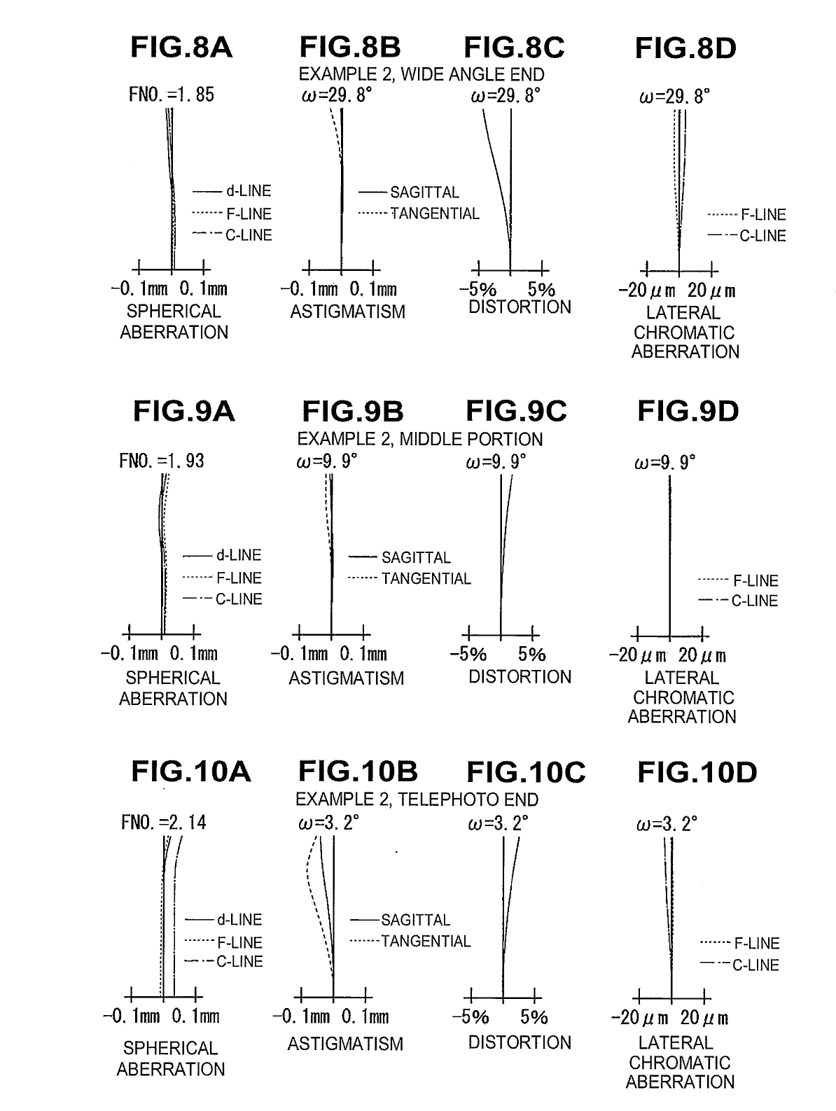

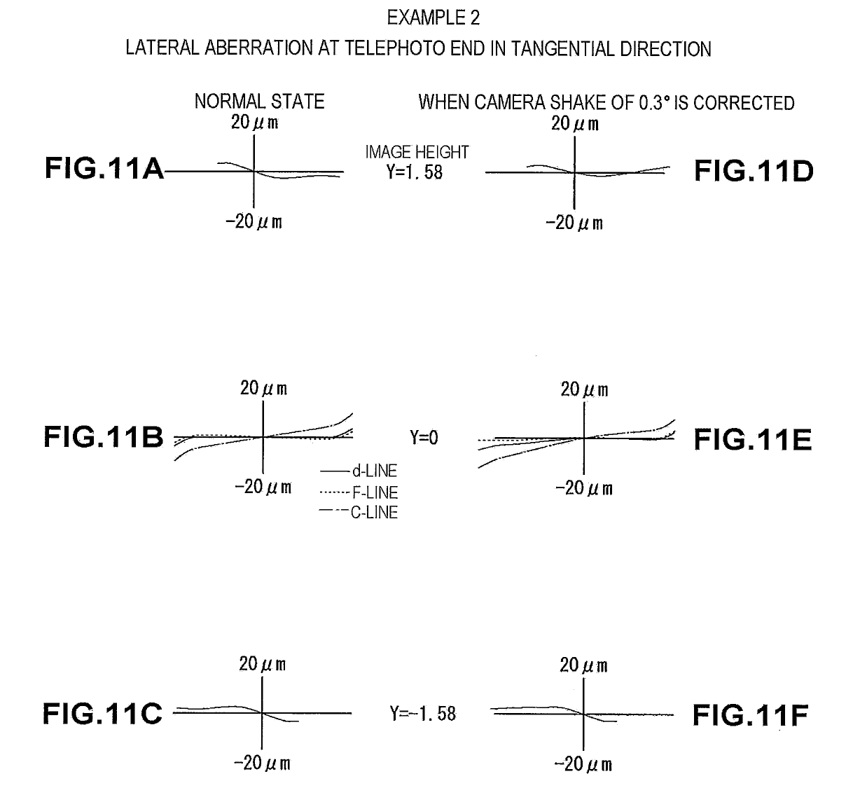

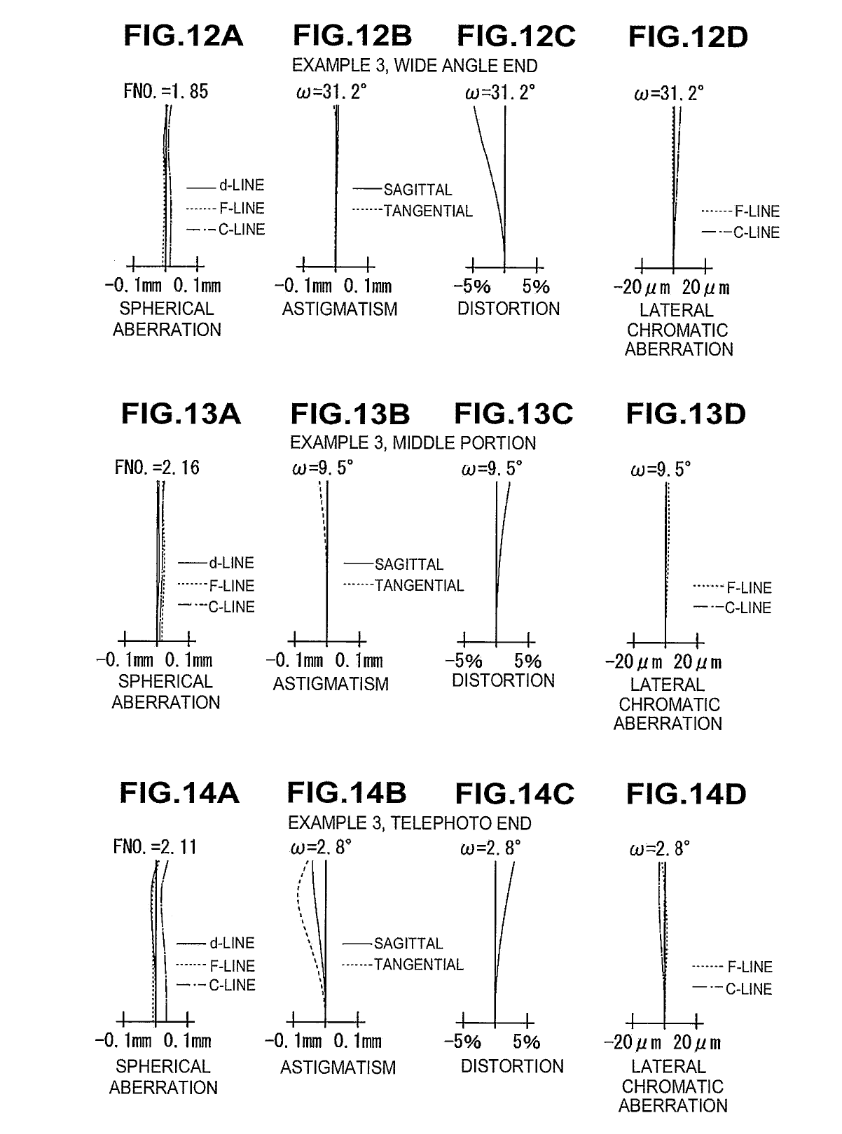

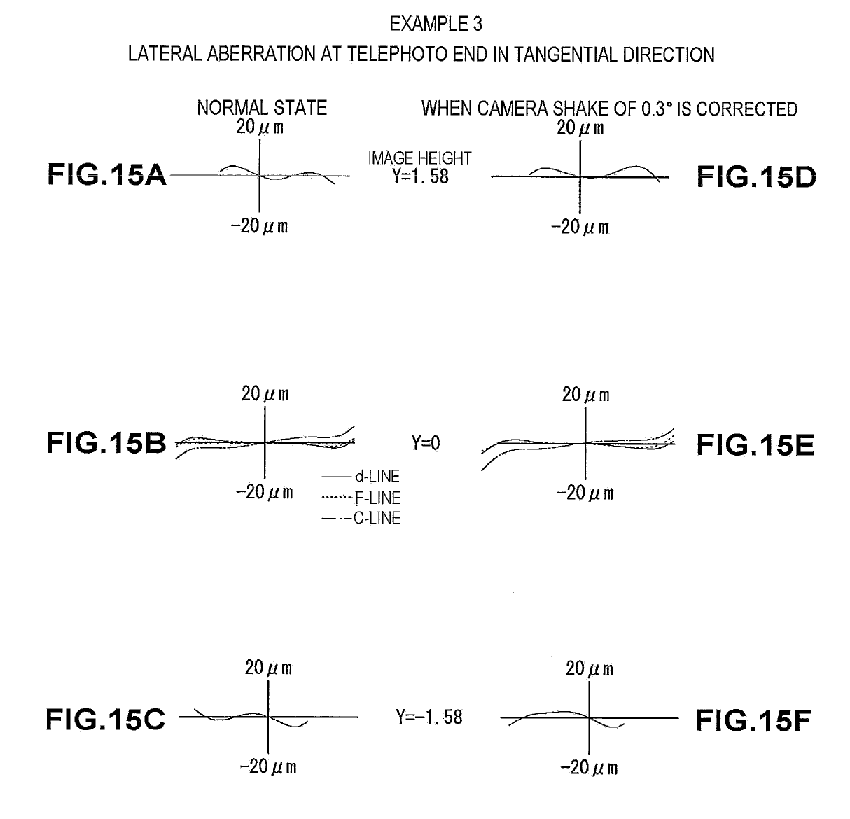

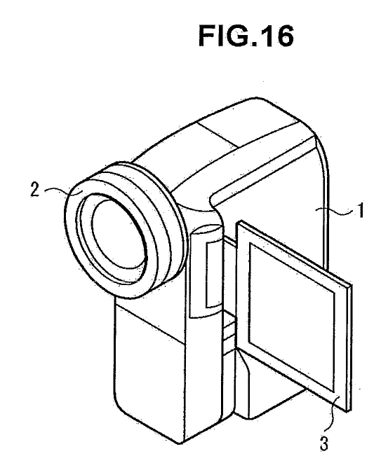

Similarly, FIGS. 8A to 8D show all aberrations of the zoom lens according to Example 2 (at the wide angle end). FIGS. 9A to 9D show all aberrations of the zoom lens according to Example 2 (in the middle portion). FIGS. 10A to 10D show all aberrations of the zoom lens according to Example 2 (at the telephoto end). FIGS. 11A to 11F show the lateral aberration of the zoom lens according to Example 2 in a normal state and when a camera shake of 0.3° is corrected. Similarly, FIGS. 12A to 12D, FIGS. 13A to 13D, and FIGS. 14A to 14D and FIGS. 15A to 15F show all aberrations of the zoom lenses according to Example 3.

As can be seen from the numerical data and the aberration diagrams, in all of Examples 1 to 3, the weight of the camera shake correction group is reduced and it is possible to obtain a good optical performance even when camera shake occurs.

Although the embodiments and examples of the invention have been described above, the invention is not limited thereto. Various modifications and changes of the invention can be made without departing from the scope and spirit of the invention. For example, the curvature radius, the surface spacing, and the refractive index of each lens component are not limited to the values described in the above-mentioned numerical examples, but may have other values.

What is claimed is:

1. A zoom lens comprising:
a first lens group having a positive refractive power;
a second lens group having a negative refractive power;
a third lens group having a positive refractive power; and
a fourth lens group having a positive refractive power,
wherein the first to fourth lens groups are arranged in this order from an object side and a gap between the lens groups is changed to change power,
the third lens group includes at least two partial lens groups,
one of the partial lens groups is a camera shake correction group and is moved in a direction vertical to an optical axis to correct a camera shake, and
the camera shake correction group includes two single lenses, and at least one of the single lenses is a plastic lens.

2. The zoom lens according to claim 1,
wherein the first lens group and the third lens group are fixed when power varies and during focusing,
the second lens group is moved along the optical axis when power varies, and
the fourth lens group is moved along the optical axis when power varies and during focusing.

3. The zoom lens according to claim 1,
wherein the camera shake correction group has a positive refractive power,
the two single lenses are a positive lens and a negative lens arranged in this order from the object side, and
the negative lens is a plastic lens.

4. The zoom lens according to claim 3,
wherein the positive lens of the camera shake correction group is a glass lens and satisfies the following Conditional expressions 1 and 2:
νᵢₚ−νᵢₙ>32; and [Conditional expression 1]
ρᵢₚ<3 [Conditional expression 2]
wherein νᵢₚ indicates the Abbe number of the positive lens of the camera shake correction group with respect to the d-line, νᵢₙ indicates the Abbe number of the negative lens of the camera shake correction group with respect to the d-line, and ρᵢₚ indicates the specific gravity (g/cm³) of the positive lens of the camera shake correction group.

5. The zoom lens according to claim 3,
wherein the negative lens of the camera shake correction group satisfies the following Conditional expression 3:
0.45<|fᵢₙ|/f_{T}<1.1 [Conditional expression 3]
wherein fᵢₙ indicates the focal length of the negative lens of the camera shake correction group and f_{T} indicates the focal length of the entire lens system at a telephoto end.

6. The zoom lens according to claim 1,
wherein the third lens group includes three partial lens groups, and
among the three partial lens groups, a second partial lens group from the object side is the camera shake correction group.

7. The zoom lens according to claim 6,
wherein the third lens group includes a plastic lens with a positive refractive power and satisfies the following Conditional expression 4:
0.5<f₃ₚ/f_{T}<1 [Conditional expression 4]
wherein f₃ₚ indicates the focal length of the positive plastic lens of the third lens group and f_{T} indicates the focal length of the entire lens system at the telephoto end.

8. An imaging apparatus comprising:
the zoom lens according to claim 1; and
an imaging device that outputs an image signal corresponding to an optical image formed by the zoom lens.
